(19) United States
(12) Patent Application Publication
(10) Pub. No.: US 2023/0088015 A1
(43) Pub. Date: Mar. 23, 2023

(54) RANGE-FINDING METHOD, RANGE-FINDING APPARATUS, RANGE-FINDING SYSTEM, AND NON-TRANSITORY COMPUTER-READABLE STORAGE MEDIUM

(71) Applicant: Shenzhen Reolink Technology Co., Ltd., Shenzhen (CN)

(72) Inventors: Xiaoyu LIU, Shenzhen (CN); Sheng YONG, Shenzhen (CN); Rui ZHOU, Shenzhen (CN)

(21) Appl. No.: 17/692,101

(22) Filed: Mar. 10, 2022

(30) Foreign Application Priority Data
Sep. 17, 2021 (CN) 202111094463.5

(51) Int. Cl. G01S 1/04

(52) U.S. Cl. CPC G01S 1/0428; G01S 1/045

(57) ABSTRACT

The present invention provides a range-finding method, apparatus, system, and non-transitory computer-readable storage medium. The method includes: acquiring a predicted number of interrupts of a single-chip microcomputer; acquiring a to-be-measured signal; triggering a first output of a comparator according to a strength of the to-be-measured signal and a preset trigger threshold; recording an ultrasonic signal and acquiring an actual number of interrupts according to the first output; and adjusting the trigger threshold according to the predicted number of interrupts and the actual number of interrupts, where the adjusted trigger threshold is used to trigger the first output next time. The trigger threshold of the comparator can be adaptively adjusted according to the number of interrupts to adjust sensitivity of recording the ultrasonic signal, so as to adapt to different measurement environments and ranges, accurately record an arrival time of the ultrasonic signal, and improve the accuracy of a range-finding result.

### FIELD OF THE INVENTION

This application relates to the field of range-finding, and more specifically, to a range-finding method, a range-finding apparatus, a range-finding system, and a non-transitory computer-readable storage medium.

### BACKGROUND OF THE INVENTION:

Some range-finding methods are to measure a distance by transmitting a range-finding signal and acquiring a “flight time” of the range-finding signal. Accurately determining an arrival time of the range-finding signal is a key to an accurate range-finding result. In some range-finding scenarios, a to-be-measured object is a moving object. The “flight distance” of the range-finding signal varies with a distance to be measured. A longer “flight distance” leads to a higher attenuation of the range-finding signal. Therefore, it is difficult to accurately identify the arrival time of the range-finding signal.

### SUMMARY OF THE INVENTION:

Implementations of this application provide a range-finding method, a range-finding apparatus, a range-finding system, and a non-transitory computer-readable storage medium.

The range-finding method in the implementations of this application includes: acquiring a predicted number of interrupts by a single-chip microcomputer; acquiring a received signal; triggering a first output by a comparator according to a strength of the received signal and a preset trigger threshold; recording an ultrasonic signal and acquiring an actual number of interrupts according to the first output; and adjusting the trigger threshold according to the predicted number of interrupts and the actual number of interrupts, where the adjusted trigger threshold is used to trigger the first output next time.

The range-finding apparatus in the implementations of this application includes a comparator and a single-chip microcomputer. The comparator is configured to acquire a received signal and trigger a first output according to a strength of the received signal and a preset trigger threshold. The single-chip microcomputer is connected to the comparator and configured to acquire a predicted number of interrupts, record an ultrasonic signal and acquire an actual number of interrupts according to the first output, and adjust the trigger threshold according to the predicted number of interrupts and the actual number of interrupts, where the adjusted trigger threshold is used to trigger the first output next time.

The range-finding system in the implementations of this application includes a transmitting terminal and a receiving terminal. The transmitting terminal is configured to transmit an ultrasonic signal to the receiving terminal. The receiving terminal includes a range-finding apparatus. The range-finding apparatus includes a comparator and a single-chip microcomputer. The comparator is configured to acquire a received signal and trigger a first output according to a strength of the received signal and a preset trigger threshold. The single-chip microcomputer is connected to the comparator and is configured to acquire a predicted number of interrupts, record an ultrasonic signal and acquire an actual number of interrupts according to the first output, and adjust the trigger threshold according to the predicted number of interrupts and the actual number of interrupts, where the adjusted trigger threshold is used to trigger the first output next time.

The non-transitory computer-readable storage medium in the implementations of this application includes a computer program. The computer program, when executed by one or more processors, causes the one or more processors to perform the following range-finding method: acquiring a predicted number of interrupts of a single-chip microcomputer; acquiring a received signal; triggering a first output of a comparator according to a strength of the received signal and a preset trigger threshold; recording an ultrasonic signal and acquiring an actual number of interrupts according to the first output; and adjusting the trigger threshold according to the predicted number of interrupts and the actual number of interrupts, where the adjusted trigger threshold is used to trigger the first output next time.

By means of the range-finding method, the range-finding apparatus, the range-finding system, and the non-transitory computer-readable storage medium in the implementations of this application, the trigger threshold of the comparator can be adaptively adjusted according to the number of interrupts of the single-chip microcomputer to adjust sensitivity of recording the ultrasonic signal, so as to adapt to different measurement environments and measurement ranges, accurately record an arrival time of the ultrasonic signal, and improve the accuracy of a range-finding result.

Additional aspects and advantages of the implementations of this application will be given in the following descriptions, some of which will become apparent from the following descriptions or may be learned through practices of the implementations of this application.

### BRIEF DESCRIPTION OF THE DRAWINGS:

The foregoing and/or additional aspects and advantages of this application will become apparent and comprehensible from the descriptions of the implementations below with reference to the accompanying drawings.

FIG. 1 is a schematic flowchart of a range-finding method according to some implementations of this application.

FIG. 2 is a schematic structural diagram of a range-finding apparatus according to some implementations of this application.

FIG. 3 is a schematic structural diagram of a range-finding system according to some implementations of this application.

FIG. 4 is a schematic flowchart of a range-finding method according to some implementations of this application.

FIG. 5 is a schematic flowchart of a range-finding method according to some implementations of this application.

FIG. 6 is a schematic flowchart of a range-finding method according to some implementations of this application.

FIG. 7 is a schematic flowchart of a range-finding method according to some implementations of this application.

FIG. 8 is a schematic flowchart of a range-finding method according to some implementations of this application.

FIG. 9 is a schematic structural diagram of a receiving terminal of a range-finding method according to some implementations of this application.

FIG. 10 is a schematic diagram of a connection status between a computer-readable storage medium and a processor according to some implementations of this application.

### DETAILED DESCRIPTION:

The following describes implementations of this application in detail. Examples of the implementations are shown in the accompanying drawings, and same or similar reference signs in all the accompanying drawings indicate same or similar components or components having same or similar functions. The implementations described below with reference to the accompanying drawings are exemplary, and are intended to explain the implementations of this application and cannot be construed as limitations on the implementations of this application.

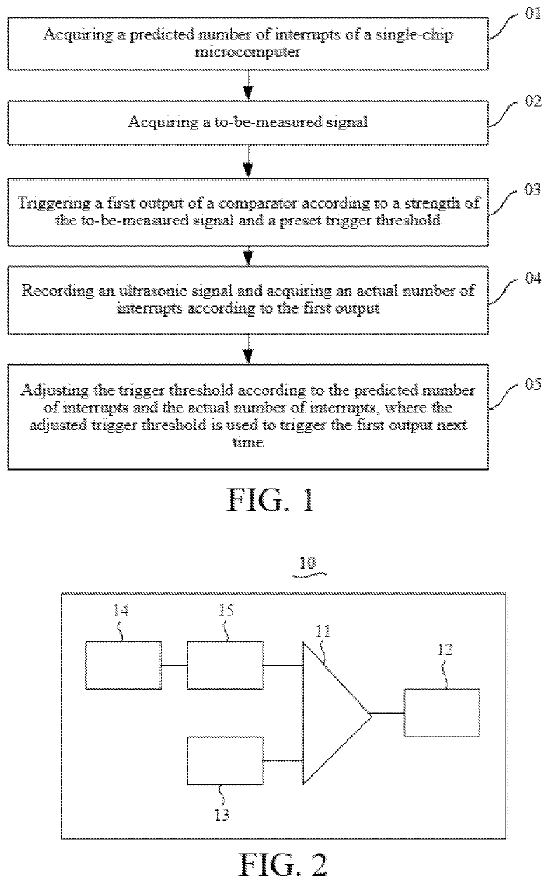

Referring to FIG. 1 to FIG. 3, an implementation of this application provides a range-finding method. The range-finding method includes the following steps:

01: Acquiring a predicted number of interrupts of a single-chip microcomputer 12.

02: Acquiring a received signal.

03: Triggering a first output of a comparator 11 according to a strength of the received signal and a preset trigger threshold.

04: Recording an ultrasonic signal and acquiring an actual number of interrupts according to the first output.

05: Adjusting the trigger threshold according to the predicted number of interrupts and the actual number of interrupts, where the adjusted trigger threshold is used to trigger the first output next time.

Referring to FIG. 2, an implementation of this application provides a range-finding apparatus 10. The range-finding apparatus 10 includes a comparator 11 and a single-chip microcomputer 12. The comparator 11 is configured to acquire a received signal and trigger a first output according to a strength of the received signal and a preset trigger threshold. The single-chip microcomputer 12 is connected to the comparator 11. The single-chip microcomputer 12 is configured to acquire a predicted number of interrupts, record an ultrasonic signal and acquire an actual number of interrupts according to the first output, and adjust the trigger threshold according to the predicted number of interrupts and the actual number of interrupts, where the adjusted trigger threshold is used to trigger the first output next time.

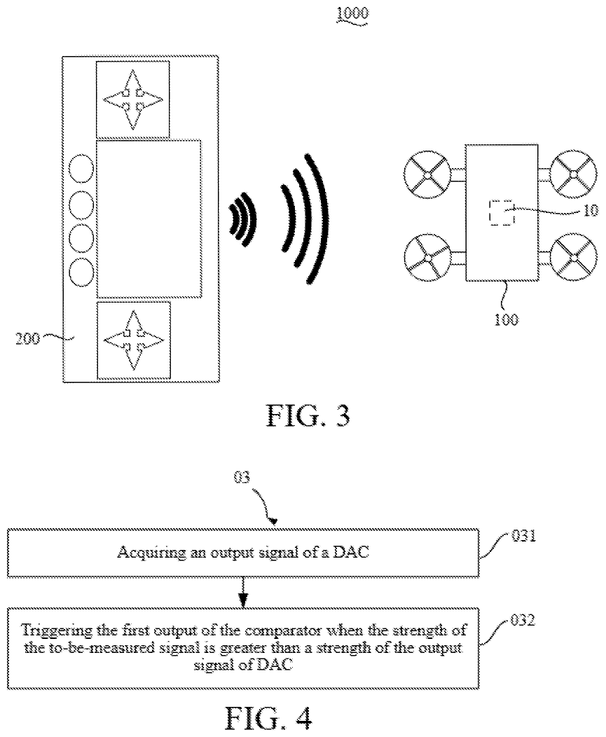

Referring to FIG. 3, an implementation of this application provides a range-finding system 1000, and the range-finding system 1000 includes a transmitting terminal 200 and a receiving terminal 100. The transmitting terminal 200 is configured to transmit an ultrasonic signal to the receiving terminal 100 for range-finding. The receiving terminal 100 includes a range-finding apparatus 10, such as the range-finding apparatus 10 shown in FIG. 2. The range-finding apparatus is configured to detect the ultrasonic signal transmitted by the transmitting terminal 200 for range-finding.

In an embodiment, the transmitting terminal 200 and the receiving terminal 100 may be a remote control device and a movable platform, respectively. For example, the transmitting terminal 200 is a remote controller, and the receiving terminal 100 is an unmanned aerial vehicle (UAV), an unmanned vehicle, an intelligent robot, or the line, which is not listed herein. In another embodiment, the transmitting terminal 200 and the receiving terminal 100 may be a signal station and the movable platform respectively. For example, the transmitting terminal 200 is a base station, and the receiving terminal 100 is a UAV. For another example, the transmitting terminal 200 is a charging station of a sweeping robot, and the receiving terminal 100 is the sweeping robot. For another example, the transmitting terminal 200 is a parking navigator in a parking lot, and the receiving terminal 100 is a vehicle. In still another embodiment, the transmitting terminal 200 and the receiving terminal 100 may be an electronic device and a beacon respectively. For example, the transmitting terminal 200 is an electronic device such as a mobile phone, a camera, a smart watch, or a head-mounted display device, and the receiving terminal 100 is a calibration board. Based on the above embodiments, the transmitting terminal 200 and the receiving terminal 100 each may be a fixed object or a movable object. In the above embodiment, an object used as the transmitting terminal 200 may alternatively be used as the receiving terminal 100, and an object used as the receiving terminal 100 may alternatively be used as the transmitting terminal 200. For example, in an embodiment, the transmitting terminal 200 is a UAV, an unmanned vehicle, an intelligent robot, or the like, and the receiving terminal 100 is a remote controller or a receiving apparatus of the UAV, the unmanned vehicle, or the intelligent robot. The receiving apparatus is configured to provide supply, detection, maintenance, and the like to the UAV, the unmanned vehicle, or the intelligent robot. It should be noted that the types of the transmitting terminal 200 and the receiving terminal 100 in this implementation of this application are not limited to the types listed in the above embodiment, and are not limited herein.

Referring to FIG. 1 to FIG. 3, the predicted number of interrupts and the actual number of interrupts are a number of level jumps of the comparator 11. Specifically, when the first output of the comparator 11 is triggered, a level of the comparator 11 jumps. The single-chip microcomputer 12 detects that the level jump of the comparator 11 triggers an interrupt.

In a preset transmit-receive period, the transmitting terminal 200 transmits a predetermined number of ultrasonic signals to the receiving terminal 100 at a preset transmitting period. Therefore, the predicted number of interrupts may be calculated. That is to say, a number of level jumps of the comparator 11 that can be triggered by receiving the ultrasonic signal in an ideal condition may be calculated.

In addition to the ultrasonic signals, the receiving terminal 100 may receive an interference signal, such as an environmental noise signal. In this implementation of this application, the received signal is a signal received by the receiving terminal 100, and may include an ultrasonic signal and an interference signal.

The comparator 11 is configured to identify the ultrasonic signal from the received signal. Specifically, the comparator 11 includes two input terminals. The ultrasonic signal is inputted to the comparator 11 from one of the input terminals. A preset comparison voltage is inputted to another of the input terminals of the comparator 11. In one embodiment, when a voltage of the received signal is greater than the comparison voltage, the comparator 11 outputs a binary signal “1”, that is, the comparator 11 triggers a first output. When the voltage of the received signal is less than or equal to the comparison voltage, the comparator 11 outputs a binary signal “0”, that is, the comparator 11 triggers a second output; A value of the preset comparison voltage is used as the trigger threshold. The received signal is positively related to the strength of the received signal. A higher strength of the received signal leads to a higher corresponding voltage. In this way, the comparator 11 may detect the strength of the received signal according to the trigger threshold. When the voltage of the received signal is greater than or equal to the comparison voltage, it indicates that the strength of the received signal is strong enough, and the received signal is probably the ultrasonic signal transmitted by the transmitting terminal 200 rather than the interference signal. In this way, when the comparator 11 triggers the first output, the received signal that triggers the first output of the comparator 11 may be recorded as the ultrasonic signal, thereby identifying the ultrasonic signal. In addition, a time stamp at which the received signal that triggers the first output of the comparator 11 is received may be recorded, so as to acquire a moment at which the receiving terminal 100 receives the ultrasonic signal for the range-finding calculation.

During recording of the ultrasonic signal according to the first output, the single-chip microcomputer 12 detects an interrupt caused by the first output and records the actual number of interrupts. By comparing the predicted number of interrupts with the actual number of interrupts, it may be determined whether a current trigger threshold is applicable to a range-finding environment at a current distance. In an ideal condition, the predicted number of interrupts is equal to the actual number of interrupts. It indicates that each ultrasonic signal is accurately identified and recorded. In the actual measurement environment, if the actual number of interrupts is greater than the predicted number of interrupts, the interference signal may be falsely recorded as the ultrasonic signal, resulting in a larger actual number of interrupts. The trigger threshold may be increased to further filter out the interference signal. If the actual number of interrupts is less than the predicted number of interrupts, it indicates that the ultrasonic signal decreases in strength as a result of attenuation and therefore fails to trigger the first output of the comparator 11, resulting in missing detection or recording of the ultrasonic signal. The trigger threshold may be reduced to avoid missing detection and recording of the ultrasonic signal. If the actual number of interrupts is close to the predicted number of interrupts, it may be considered that the ultrasonic signal is identified and recorded relatively accurately. In this case, the trigger threshold is not required to be adjusted. Alternatively, the trigger threshold may be adjusted properly according to the actual number of interrupts and the predicted number of interrupts, which is not limited herein. The adjusted trigger threshold is used to trigger the first output next time, so as to quickly adapt to the current measurement environment. In this way, it is ensured that the ultrasonic signal is accurately identified and recorded in the current measurement environment and the recorded arrival time stamp of the ultrasonic signal is accurate.

By means of the range-finding method, the range-finding apparatus 10, and the range-finding system 1000 in the implementations of this application, the trigger threshold of the comparator 11 can be adaptively adjusted according to the number of interrupts of the single-chip microcomputer 12 to adjust sensitivity of recording the ultrasonic signal, so as to adapt to different measurement environments and measurement ranges, accurately record the arrival time of the ultrasonic signal, and improve the accuracy of a range-finding result.

Further description is provided below with reference to the accompanying drawings.

Referring to FIG. 4, in some implementations, 03 of triggering the first output of the comparator 11 according to the strength of the received signal and the preset trigger threshold includes the following steps:

031: Acquiring an output signal of a digital to analog converter (DAC 13).

032: Triggering the first output of the comparator 11 when the strength of the received signal is greater than a strength of the output signal of the DAC 13.

Referring to FIG. 2 and FIG. 3, in some implementations, the range-finding apparatus 10 of the receiving terminal 100 further includes the DAC 13. The DAC 13 is connected to the comparator 11 and the single-chip microcomputer 12. The DAC 13 is configured to output the signal. The comparator 11 is configured to trigger the first output according to the strength of the received signal and the strength of the signal outputted by DAC 13. The single-chip microcomputer 12 is configured to adjust an output power of the DAC 13 to adjust the trigger threshold of the comparator 11.

Referring to FIG. 2 and FIG. 3, specifically, the output signal of the DAC 13 generates a comparison voltage to form the trigger threshold of the comparator 11. Specifically, when the strength of the received signal is greater than the strength of the output signal of DAC 13, the first output of the comparator 11 is triggered, and the received signal is recorded as the ultrasonic signal. The voltage of DAC 13 can be easily adjusted. When the trigger threshold is required to be increased, only the strength of the output signal of the DAC 13 is required to be increased to increase the comparison voltage. In this way, the trigger threshold can be increased. When the trigger threshold is required to be reduced, only the strength of the output signal of the DAC 13 is required to be reduced to reduce the comparison voltage. In this way, the trigger threshold can be reduced.

For example, an initial preset comparison voltage is 15V. The DAC 13 outputs a signal according to a predetermined parameter to generate the comparison voltage of 15V. If the voltage generated by the received signal is less than or equal to 15V, the comparator 11 maintains a high level, maintains the second output, and outputs a binary signal “0”. If the voltage generated by the received signal is greater than 15V, the comparator 11 jumps to a low level, triggers the first output, and outputs the binary signal “1”. The single-chip microcomputer 12 records the arrival time stamp of the ultrasonic signal when receiving the binary signal “1”. If the trigger threshold is required to be increased, the single-chip microcomputer 12 sends an adjustment signal to control the DAC 13 to increase the output. If the trigger threshold is required to be reduced, the single-chip microcomputer 12 sends an adjustment signal to control the DAC 13 to reduce the output.

The single-chip microcomputer 12 may adjust a signal output strength of the DAC 13 according to the predicted number of interrupts and the actual number of interrupts, so as to adjust the trigger threshold accordingly. In this way, the trigger threshold of the comparator 11 can adapt to the current measurement environment.

In some implementations, the single-chip microcomputer 12 acquires a predicted number of interrupts in one measurement period, and performs interrupt detection in the measurement period to count the actual number of interrupts. The measurement period may be a time interval from a moment at which the transmitting terminal 200 transmits an ultrasonic signal to a moment at which the transmitting terminal 200 transmits a next ultrasonic signal. Upon or before ending of the measurement period, the single-chip microcomputer 12 compares the predicted number of interrupts with the actual number of interrupts, and adjusts the trigger threshold according to a comparison result. The adjusted trigger threshold is used to trigger the first output next time. In this embodiment, the expression “the adjusted trigger threshold is used to trigger the first output next time” means that the adjusted trigger threshold is used to trigger the first output in a next measurement period.

For example, the measurement frequency is 20 Hz. The trigger threshold is adjusted by adjusting the strength of the output signal of DAC 13. An update frequency for the DAC 13 is greater than or equal to 20 Hz to ensure that the adjustment of the trigger threshold can be completed before or upon the beginning of the next measurement period.

Referring to FIG. 2 and FIG. 3, in some implementations, the range-finding apparatus 10 of the receiving terminal 100 further includes a receiver 14 and an amplifier 15. The receiver 14 is configured to receive a to-be-measured signal. The amplifier 15 is connected to the receiver 14 and the comparator 11. The amplifier 15 is configured to transmit the received signal to the comparator 11. In the range-finding system 1000, the receiver 14 may be an ultrasonic microphone.

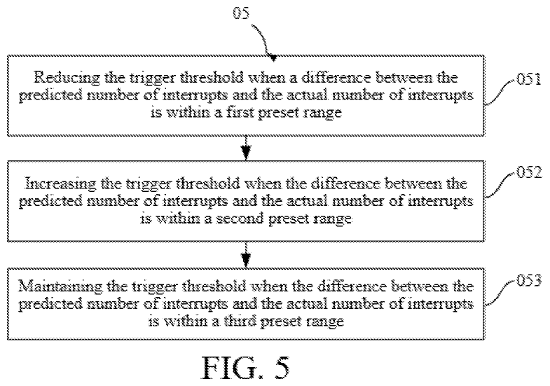

Referring to FIG. 5, in some implementations, 05 of adjusting the trigger threshold of the comparator 11 according to the predicted number of interrupts and the actual number of interrupts includes the following steps:

051: Reducing the trigger threshold when a difference between the predicted number of interrupts and the actual number of interrupts is within a first preset range.

052: Increasing the trigger threshold when the difference between the predicted number of interrupts and the actual number of interrupts is within a second preset range.

053: Maintaining the trigger threshold unchanged when the difference between the predicted number of interrupts and the actual number of interrupts is within a third preset range.

In an embodiment, the first preset range is [2, +∞), the second preset range is (−∞, −2], and the third preset range is [-2, 2]. As an example, it is assumed that the predicted number of interrupts is M and the actual number of interrupts is N. When M−N=2, which indicates that the difference between the predicted number of interrupts and the actual number of interrupts is within the third preset range, the trigger threshold is maintained. When M−N=−3, which indicates that the difference between the predicted number of interrupts and the actual number of interrupts is within the second preset range, the trigger threshold is increased. In this way, a difference between the predicted number of interrupts and the actual number of interrupts in the next measurement period can return to the third preset range. When M−N=4, which indicates that the difference between the predicted number of interrupts and the actual number of interrupts is within the first preset range, the trigger threshold is reduced. In this way, the difference between the predicted number of interrupts and the actual number of interrupts in the next measurement period can return to the third preset range. The third preset range is used as an allowable error range. The trigger threshold is maintained when the difference between M and N is within the third preset range, so as to avoid an excessive jitter of the actual number of interrupts N in a different measurement period as a result of frequent adjustment of the trigger threshold.

In this way, the range-finding apparatus 10 can adaptively adjust the trigger threshold according to a value of a measured distance/the strength of the ultrasonic signal. Therefore, missing and false ultrasonic signal detection is reduced, and the range-finding accuracy of the range-finding apparatus 10 is improved. The range-finding apparatus 10 adaptively adjusts the trigger threshold according to the strength of the ultrasonic signal. Therefore, the difference between the predicted number of interrupts and the actual number of interrupts can return to the third preset range before divergence. In this way, the adaptive adjustment system has high robustness.

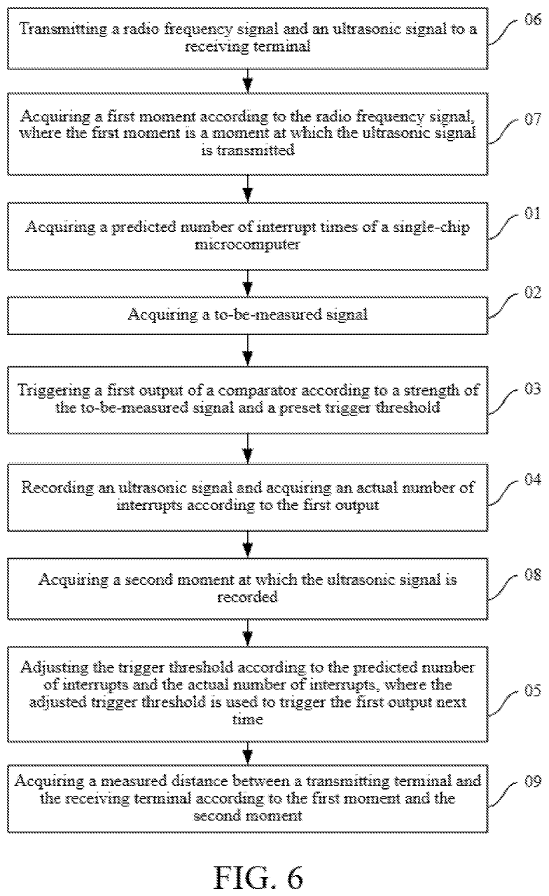

Referring to FIG. 6, in some implementations, the range-finding method further includes the following steps:

06: Transmitting a radio frequency signal and the ultrasonic signal to a receiving terminal 100.

07: Acquiring a first moment according to the radio frequency signal, wherein the first moment is a moment at which the ultrasonic signal is transmitted.

08: Acquiring a second moment at which the ultrasonic signal is recorded.

09: Acquiring a measured distance between a transmitting terminal 200 and the receiving terminal 100 according to the first moment and the second moment.

Referring to FIG. 2 and FIG. 3, in some implementations, the transmitting terminal 200 is further configured to transmit the radio frequency signal to the receiving terminal 100. The receiving terminal 100 is configured to acquire the first moment according to the radio frequency signal, where the first moment is a moment at which the ultrasonic signal is transmitted; acquire the second moment at which the ultrasonic signal is recorded and acquire the actual number of interrupts; and acquire the measured distance between the transmitting terminal 200 and the receiving terminal 100 according to the first moment and the second moment.

In some implementations, a transmission delay of the radio frequency signal is so small that the transmission delay can be ignored. The transmitting terminal 200 transmits the radio frequency signal and the ultrasonic signal at the same time. Since the transmission delay of the radio frequency signal is extremely small, the time stamp (that is, the first moment) at which the receiving terminal 100 receives the radio frequency signal may be used as the time stamp of transmitting the ultrasonic signal (that is, the moment at which the ultrasonic signal is transmitted).

In some implementations, the transmission delay of a radio frequency signal is known. The transmission delay of the radio frequency signal is a period time from the moment at which the transmitting terminal 200 transmits the radio frequency signal to the moment at which the receiving terminal 100 receives the radio frequency signal. The transmitting terminal 200 first transmits the radio frequency signal, and then transmits the ultrasonic signal after a period of time tx. The period of time tx is greater than a maximum transmission delay of the radio frequency signal, so as to ensure that the receiving terminal 100 first receives the radio frequency signal and then receives the ultrasonic signal. The first moment is set to tl. The moment at which the receiving terminal 100 receives the radio frequency signal is to, and the transmission delay of the radio frequency signal is ty. In this implementation, the first moment t1=t0−ty+tx.

Further, in some implementations, in each range-finding period, the receiver 14 of the receiving terminal 100 and the single-chip microcomputer 12 start to detect the received signal at the moment tl. Before the moment t1, for example, in a period of time from the moment t0 to the moment t1, the single-chip microcomputer 12 adjusts the trigger threshold according to a predicted number of interrupts and an actual number of interrupts in a previous range-finding period, and applies the trigger threshold to the current range-finding.

When the comparator 11 triggers the first output, the single-chip microcomputer 12 records the ultrasonic signal, and uses, as the second moment, the moment at which the ultrasonic signal is recorded, that is, the moment at which the comparator 11 triggers the first output. The second moment reflects the moment at which the receiving terminal 100 receives the ultrasonic signal.

It is assumed that the first moment is t1, the second moment is t2, the measured distance is d, and a propagation speed of an ultrasonic wave is v. The measured distance d may be calculated according to the first moment t1, the second moment t2, and the propagation speed v of an ultrasonic wave, that is, d=(t2−t1)v.

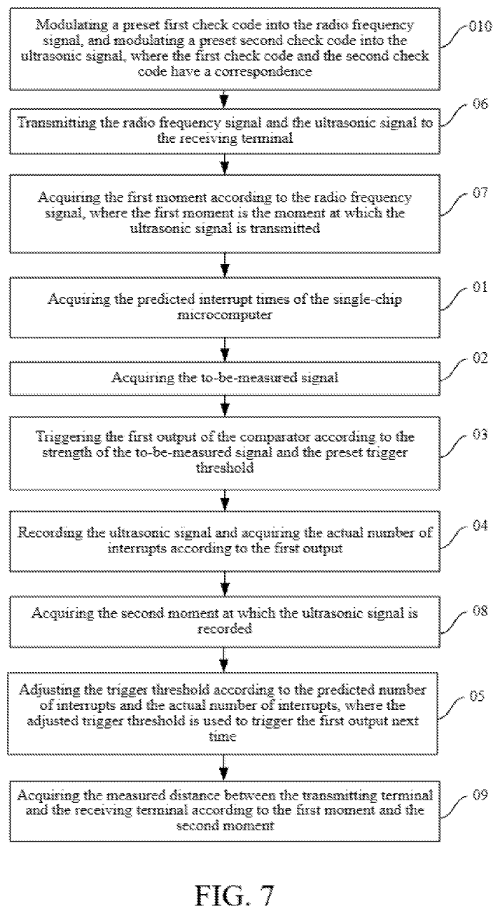

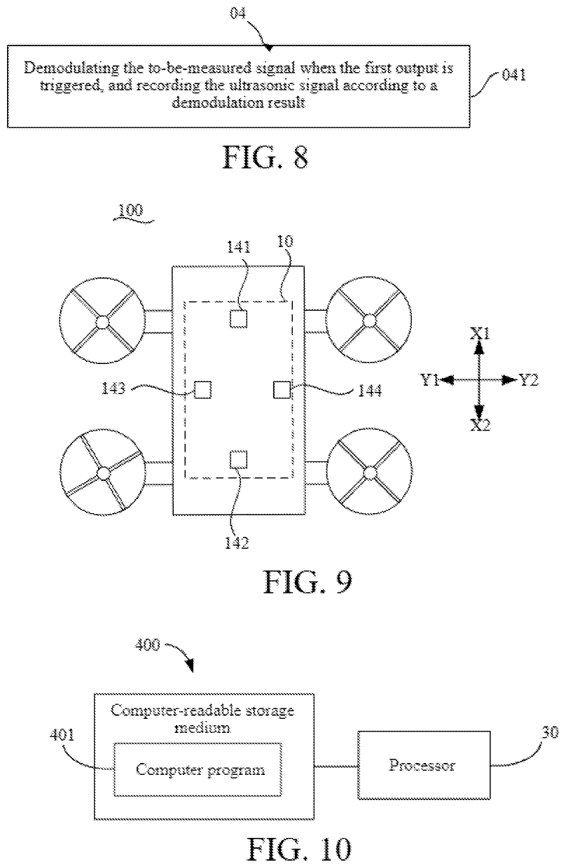

Referring to FIG. 7 and FIG. 8, in some implementations, the range-finding method further includes the following steps:

010: Modulating a preset first check code into the radio frequency signal, and modulating a preset second check code into the ultrasonic signal, where the first check code and the second check code have a correspondence.

04 of recording the ultrasonic signal according to the first output includes the following steps:

041: Demodulating the received signal when the first output is triggered, and recording the ultrasonic signal according to a demodulation result.

The first check code and the second check code may be a parity check code, a

Hamming check code, a cyclic redundancy check code, a message-digest algorithm 5 (MD5) check code, or the like, which is not limited herein.

The first check code and the second check code are configured to verify whether the received signal is the ultrasonic signal transmitted by the transmitting terminal 200. In an embodiment, the receiving terminal 100 stores a preset check table. The check table includes the correspondence between the first check code and the second check code. When the radio frequency signal is received, the radio frequency signal is demodulated to acquire the first check code, and when the first output is triggered, the received signal is demodulated. If the second check code corresponding to the first check code can be acquire after the received signal is demodulated, the received signal is recorded as an ultrasonic signal. Otherwise, the received signal is recorded as an interference signal. In this way, the ultrasonic signal can be identified in a measurement environment having strong interference signals, thereby accurately acquiring the arrival time stamp of the ultrasonic signal.

In some implementations, 01 of acquiring the predicted number of interrupts of the single-chip microcomputer 12 includes: acquiring the predicted number of interrupts according to the second check code.

After a modulation method is determined, a number of ultrasonic signals required for transmitting the second check code may be determined. That is to say, a number of ultrasonic signals transmitted by the transmitting terminal 200 in one range-finding period may be determined. The predicted number of interrupts can be acquired according to the number of ultrasonic signals transmitted by the transmitting terminal 200. That is to say, the number of interrupts of the single-chip microcomputer 12 that may be detected can be predicted.

In an embodiment, the second check code includes three decimal digits. For example, the second check code is “1, 9, 7”, and each digit includes two bits. Therefore, the second check code has 6 bits in total. The ultrasonic signal is a square wave signal having a duty cycle of fifty percent, and a positive bandwidth of the ultrasonic signal is 12 μs. In one range-finding period, a transmission time interval between every two adjacent ultrasonic signals is 1.6 ms, and each ultrasonic signal corresponds to a second check code having one bit. If the single-chip microcomputer 12 can capture three wave peaks of each ultrasonic signal, and each ultrasonic signal triggers six interrupts when the interrupt configuration of the single-chip microcomputer 12 is to capture both a rising edge and a falling edge, that is, the level jump of the comparator 11 is triggered 6 times, it is predicted that the 6-bit second check code triggers 36 interrupts in total. Therefore, the predicted number of interrupts is 36.

Referring to FIG. 9, in some implementations, the receiving terminal 100 receives a to-be-measured signal in four directions orthogonal to a horizontal direction for range-finding, and locates a horizontal location of the transmitting terminal 200 according to range-finding structures in the four directions. As shown in FIG. 9, in an embodiment, the receiving terminal 100 includes four receivers 14: a first receiver 141, a second receiver 142, a third receiver 143, and a fourth receiver 144. The four receivers respectively receive the to-be-measured signals in a first direction, a second direction, a third direction, and a fourth direction orthogonal to the horizontal direction to detect a distance between each receiver 14 and the transmitting terminal 200. Distances among the four receivers 14 are known. Therefore, the distance of the transmitting terminal 200 relative to the receiving terminal 100 (for example, a center of the receiving terminal 100) in the horizontal direction may be calculated according to the distance from the transmitting terminal 200 to each receiver 14. If the receiving terminal 100 is used as an origin to establish a plane coordinate system, a coordinate value of the transmitting terminal 200 on the coordinate plane can be determined. If the transmitting terminal 200 is used as an origin to establish a plane coordinate system, a coordinate value of the receiving terminal 100 on the coordinate plane can be determined.

Further, in some implementations, the receiving terminal 100 performs range-finding in six directions, that is, in the four directions orthogonal to horizontal direction and two opposite directions in a vertical direction, and locates the transmitting terminal 200 in a space system according to range-finding structures in the four directions. In an embodiment, the receiving terminal 100 includes four receivers 14 in the horizontal direction and two receivers 14 in the vertical direction. A height difference exists between a horizontal plane where the two receivers 14 in the vertical direction are located and a horizontal plane where the four receivers 14 in the horizontal direction are located. In this way, the coordinate value of the transmitting terminal 200 in the space system can be determined according to distances between the six receivers 14 and the transmitting terminal 200.

Referring to FIG. 10, an implementation of this application further provides a non-transitory computer-readable storage medium 400 including a computer program 401. In some implementations, the range-finding system includes a processor 30. The computer program 401, when executed by one or more processors 30, causes the one or more processors 30 to perform the range-finding method in any of the above implementations. The non-transitory computer-readable storage medium 400 may be disposed in the range-finding system 1000, or may be disposed in a cloud server or other apparatuses. In this case, the range-finding system 1000 may communicate with the cloud server or the other apparatuses to acquire the corresponding computer program 410. Referring to FIG. 2, in some implementations, the single-chip microcomputer 12 may implement the function of the processor 30 to perform the range-finding method in any of the above implementations.

Referring to FIGS. 1, 4-8, for example, the computer program 401, when executed by one or more processors 30, causes the one or more processors 30 to perform the methods in 01, 02, 03, 031, 032, 04, 041, 05, 051, 052, 053, 06, 07, 08, 09, 010, and 011. For example, the one or more processors perform the following range-finding method.

01: Acquiring the predicted number of interrupts of the single-chip microcomputer 12.

02: Acquiring the received signal.

03: Triggering the first output of the comparator 11 according to the strength of the received signal and the preset trigger threshold.

04: Recording the ultrasonic signal and acquiring the actual number of interrupts according to the first output.

05: Adjusting the trigger threshold according to the predicted number of interrupts and the actual number of interrupts, where the adjusted trigger threshold is used to trigger the first output next time.

For another example, the computer program 401, when executed by one or more processors 30, causes the one or more processors 30 to perform the following range-finding method.

010: Modulating the preset first check code into the radio frequency signal, and modulating the preset second check code into the ultrasonic signal, where the first check code and the second check code have a correspondence.

06: Transmitting the radio frequency signal and the ultrasonic signal to the receiving terminal 100.

07: Acquiring the first moment according to the radio frequency signal, where the first moment is the moment at which the ultrasonic signal is transmitted.

01: Acquiring the predicted number of interrupts of the single-chip microcomputer 12.

02: Acquiring the received signal.

03: Triggering the first output of the comparator 11 according to the strength of the received signal and the preset trigger threshold.

04: Recording the ultrasonic signal and acquiring the actual number of interrupts according to the first output.

08: Acquiring the second moment at which the ultrasonic signal is recorded.

05: Adjusting the trigger threshold according to the predicted number of interrupts and the actual number of interrupts, where the adjusted trigger threshold is used to trigger the first output next time

09: Acquiring the measured distance between the transmitting terminal 200 and the receiving terminal 100 according to the first moment and the second moment.

In the description of this specification, the description of the reference terms such as “some implementations”, “in an example”, and “exemplarily” mean that specific features, structures, materials, or characteristics described in combination with the implementations or examples is included in at least one implementation or example of this application. In this specification, schematic descriptions of the foregoing terms are not necessarily with respect to the same implementation or example. In addition, the described specific characteristics, structures, materials, or features may be combined in a proper manner in any one or more implementations or examples. In addition, with no conflict, a person skilled in the art can integrate and combine different embodiments or examples and features of the different embodiments and examples described in this specification.

Any process or method in the flowcharts or described herein in another manner may be understood as indicating a module, a segment, or a part including code of one or more executable instructions for implementing a particular logical function or process step. In addition, the scope of preferred embodiments of this application includes other implementations which do not follow the order shown or discussed, including performing, according to involved functions, the functions basically simultaneously or in a reverse order, which should be understood by technical personnel in the technical field to which the embodiments of this application belong.

Although the implementations of this application have been shown and described above, it should be understood that the above implementations are exemplary and should not be construed as a limitation on this application. A person skilled in the art may make changes, modifications, replacements and variations to the above implementations within the scope of this application.

What is claimed is:

1. A range-finding method, comprising:
acquiring a predicted number of interrupts of a single-chip microcomputer;
acquiring a signal received by a receiving terminal, wherein the received signal includes an ultrasonic signal and/or an interface signal;
triggering a first output of a comparator according to a strength of the received signal and a preset trigger threshold;
recording the received signal as an ultrasonic signal first output of the comparator is triggered;
acquiring an actual number of interrupts caused by the first output;
adjusting the trigger threshold according to the predicted number of interrupts and the actual number of interrupts, wherein the adjusted trigger threshold is used to trigger the first output next time;
wherein adjusting ihe trigger threshold according to the predicted number of interrupts and the actual number of interrupts comprising:
reducing the trigger threshold when a difference between the predicted number of interrupts and the actual number of interrupts is within a first preset range,
increasing the trigger threshold when the difference between the predicted number of interrupts and the actual number of interrupts is within a second preset range; and
maintaining the trigger threshold unchanged when the difference between the predicted number of interrupts and the actual number of interrupts third preset range.

2. The range-finding method according to claim 1, wherein the predicted number of interrupts and the actual number of interrupts are a number of level jumps of the comparator.

3. The range-finding method according to claim 1, wherein, the triggering a first output of a comparator according to a strength of the received signal and a preset trigger threshold comprises:
acquiring an output signal of a digital to analog converter (DAC); and
triggering the first output of the comparator when the strength of the received signal is greater than a strength of the output signal of the DAC.

4. (canceled)

5. The range-finding method according to claim 1, further comprising:
transmitting a radio frequency signal and the ultrasonic signal to the receiving terminal;
acquiring a first moment according to the radio frequency signal, wherein the first moment is a moment at which the ultrasonic signal is transmitted;
acquiring a second moment at which the ultrasonic signal is recorded; and
acquiring a measured distance between a transmitting terminal and the receiving terminal according to the first moment and the second moment.

6. A range-finding apparatus, comprising:
a comparator, configured to acquire a received signal and trigger a first output according to a strength of the received signal and a preset trigger threshold, wherein the received signal includes an ultrasonic signal and/or an interference signal received by a receiving terminal; and
a single-chip microcomputer, connected to the comparator and configured to acquire a predicted number of interrupts, record the received signal that triggers the first output as an ultrasonic signal when the comparator triggers the first output and acquire an actual number of interrupts caused by the first output, and adjust the trigger threshold according to the predicted number of interrupts and the actual number of interrupts, wherein the adjusted trigger threshold is used to trigger the first output next time; and
wherein the single-chip microcomputer is farther configured to:
reduce the trigger threshold when a difference between the predicted number of interrupts and the actual number of interrupts is within a first preset range;
increase the trigger threshold when the difference between the predicted number of interrupts and the actual number of interrupts is within a second preset range, and
maintain the trigger threshold unchanged when the difference between the predicted number of interrupts and the actual number of interrupts is within a third preset range.

7. The range-finding apparatus according to claim 6, further comprising a digital to analog converter (DAC) connected to the comparator and the single-chip microcomputer and configured to output a signal, wherein the comparator is configured to trigger the first output according to the strength of the received signal and a strength of the signal outputted by the DAC, and the single-chip microcomputer is configured to adjust the output signal of the DAC to adjust the trigger threshold of the comparator.

8. The range-finding apparatus according to claim 6, further comprising:
a receiver, configured to receive the received signal; and
an amplifier, connected to the receiver and the comparator and configured to transmit an amplified received signal to the comparator.

9. A range-finding system, comprising a transmitting terminal and a receiving terminal, wherein
the transmitting terminal is configured to transmit an ultrasonic signal to the receiving terminal; and
the receiving terminal comprises a range-finding apparatus comprising:
a comparator, configured to acquire a received signal and trigger a first output according to a strength of the received signal and a preset trigger threshold, wherein the received signal includes an ultrasonic signal and/or an interference signal received by a receiving terminal; and
a single-chip microcomputer, connected to the comparator and configured to acquire a predicted number of interrupts, record the received signal that triggers the first output an an ultrasonic signal when the comparator triggers the first output and acquire an actual number of interrupts caused by the first output, and adjust the trigger threshold according to the predicted number of interrupts and the actual number of interrupts, wherein the adjusted trigger threshold is used to trigger the first output next time; and
wherein the single-chip microcomputer is further configured to:
reduce the trigger threshold when a difference between the predicted number of interrupts and the actual number of interrupts is within a first preset range;
increase the trigger threshold when the difference between the predicted number of interrupts and the actual number of interrupts is within a second preset range; and
maintain the trigger threshold unchanged when the difference between the predicted number of interrupts and the actual number of interrupts preset range.

10. The range-finding system according to claim 9, wherein the range-finding apparatus further comprises a digital to analog converter (DAC) connected to the comparator and the single-chip microcomputer and configured to output a signal, wherein the comparator is configured to trigger the first output according to the strength of the received signal and a strength of the signal outputted by the DAC, and the single-chip microcomputer is configured to adjust the output signal of the DAC to adjust the trigger threshold of the comparator.

11. The range-finding system according to claim 9, wherein the range-finding apparatus further comprises:
a receiver, configured to receive the received signal; and
an amplifier, connected to the receiver and the comparator and configured to transmit an amplified received signal to the comparator.

12. A non-transitory computer-readable storage medium, storing a computer program, wherein the computer program, when executed by one or more processors, performs a range-finding method comprising:
acquiring a predicted number of interrupts of a single-chip microcomputer;
acquiring a signal received by a receiving terminal, wherein the received signal includes an ultrasonic signal and/or an interference signal;
triggering a first output of a comparator according to a strength of the received signal and a preset trigger threshold;
recording the received signal as an ultrasonic signal when the first output of the comparator is triggered; and
acquiring an actual number of interrupts caused by the first output;
adjusting the trigger threshold according to the predicted number of interrupts and the actual number of interrupts, wherein the adjusted trigger threshold is used to trigger the first output next time,
wherein adjusting the trigger threshold according to the predicted number of interrupts and the actual number of interrupts comprising:
reducing the trigger threshold when a difference between the predicted number of interrupts and the actual number of interrupts is within a first preset range:
increasing the trigger threshold when the difference between the predicted number of interrupts and the actual number of interrupts is within a second preset range, and
maintaining the trigger threshold unchanged when the difference between the predicted number of interrupts and the actual number of interrupts is within a third preset range.

13. The non-transitory computer-readable storage medium according to claim 12, wherein the predicted number of interrupts and the actual number of interrupts are a number of level jumps of the comparator.

14. The non-transitory computer-readable storage medium according to claim 12, wherein, the triggering a first output of a comparator according to a strength of the recevied signal and a preset trigger threshold comprises:
acquiring an output signal of a digital to analog converter (DAC); and
triggering the first output of the comparator when the strength of the received signal is greater than a strength of the output signal of the DAC.

15. (canceled) pg,24

16. The non-transitory computer-readable storage medium according to claim 12, wherein the range-finding method further comprises:
transmitting a radio frequency signal and the ultrasonic signal to receiving terminal;
acquiring a first moment according to the radio frequency signal, wherein the first moment is a moment at which the ultrasonic signal is transmitted;
acquiring a second moment at which the ultrasonic signal is recorded; and
acquiring a measured distance between a transmitting terminal and the receiving terminal according to the first moment and the second moment.
